(19) United States
(12) Patent Application Publication
(10) Pub. No.: US 2008/0092653 A1
(43) Pub. Date: Apr. 24, 2008

(54) Method of reducing the drift rate of accelerometer and accelerometer with reduced drift rate

(75) Inventors: Harold O. Seigel, Concord (CA); Djordje Mihajilovic, Concord (CA); Ivo Brcic, Concord (CA); Dhirejlal Mistry, Concord (CA); Rolf Ehrat, Concord (CA)

Correspondence Address: HARNESS, DICKEY & PIERCE, P.L.C., P.O. BOX 8910, RESTON, VA, 20195, US

(73) Assignee: Scintrex Limited

(21) Appl. No.: 11/582,392

(22) Filed: Oct. 18, 2006

(51) Int. Cl. G01P 15/00

(52) U.S. Cl. 73/514.01

(57) ABSTRACT

An accelerometer comprises a chamber and a proof mass supported by an elastic element within the chamber. The elastic element is formed of fused silica. A sensor senses displacement of the proof mass. Means to inhibit interaction of water vapour with the elastic element is provided.

### FIELD OF THE INVENTION

The present invention relates generally to accelerometers and in particular to a method of reducing the drift rate of an accelerometer and to an accelerometer with reduced drift rate.

### BACKGROUND OF THE INVENTION

Common applications of accelerometers are as gravimeters and seismometers for use in the fields of earth science and civil engineering. Gravimeters (or gravity meters) are accelerometers which measure g, the gravitational attraction of the earth from place to place and from time to time. Measurements of gravity are of importance in many branches of the earth sciences, including geologic mapping of the subsurface, natural resource development and extraction, volcanology, the environment and civil engineering, etc. There are basically two types of gravimeters in use today for such measurements, namely “absolute” and “relative” gravimeters. Absolute gravimeters measure the absolute value of g, by dropping a corner cube in a vacuum, and measuring the acceleration of the corner cube, using a laser beam which is reflected by the corner cube, and an interferometer. A good example of a modern absolute gravimeter is the FG5 instrument produced by Micro-g-LaCoste of Colorado, U.S.A. as is disclosed in U.S. Pat. No. 5,351,122.

Relative gravimeters do not provide measurements of the full value of g, but are used to measure differences in g, from place to place, or from time to time. Relative gravimeters commonly operate on the deflection, by changes in gravity, of the position of a proof mass which is supported by an elastic spring member. A good example of a modern relative gravimeter is the CG5 instrument, produced by Scintrex Limited of Ontario, Canada

Current state-of-the-art gravimeters, either absolute or relative, such as the examples mentioned above, can achieve resolutions in the order of 1 μGal (10⁻⁹ g). Absolute gravimeters currently available are however much heavier, and require more power than the relative gravimeters. Relative gravimeters are much lighter and more rugged than absolute gravimeters and are therefore, commonly preferred for man-portable field use, particularly on programs involving measurements at many stations, or in difficult terrain.

Until about 1985, most relative gravimeters were built using metal elastic springs to support the proof mass. See for example the publication entitled “Gravimetry” authored by Wolfgang Torge, Walter de Gruyter Press, Berlin-N.Y., 1989, pages 232-236. More recently, relative gravimeters with elastic elements to support the proof mass based on springs or hinges formed of fused, spun, pure silica (hereinafter referred to as “quartz elastic elements”), have become predominant, because of their improved elasticity, resistance to tares (shock-induced jumps) and other advantages relative to metal spring gravimeters.

Nevertheless, the quartz elastic element gravimeters still suffer from one shortcoming, namely long term drift. This long term drift is found to vary from instrument to instrument, in a rather unpredictable manner. It may typically start at about 1 to 3 milliGals per day, when the gravimeter is first built, and progressively reduce to about 0.3 milliGals per day after the gravimeter has been in use for some years.

For precise field gravity measurements, these portable relative gravimeters require corrections to be made for instrumental drift by periodically repeating measurements at stations previously occupied. Corrections for drift are made by linear interpolation of the measured repeat differences, on a time basis, for intervening stations. Whereas a portion of the drift of any gravimeter may be linear with time, and therefore can be removed by this post-processing, non-linear drift components do exist, especially for several days after a new power-up, and cannot be corrected by this procedure. Thus, to fully utilize the inherently high accuracy (reading resolution) possible with quartz elastic element gravimeters it is imperative to reduce the instrumental drift as much as possible.

Certain important applications for gravimeters involve stationary use, where very small temporal changes may be significant. These applications include earth tidal measurements, volcanology, and reservoir studies in hydrocarbon fields and groundwater basins. All of these applications require very precise control of the non-linear drift of the gravimeter, over long periods of time, even to within 10 μGals per annum. For such applications, quartz elastic element gravimeters have not been satisfactory because of their relatively high and variable long term drift rates.

Manufacturers of quartz elastic element gravimeters have generally assumed that the long term drift of their instruments was an intrinsic property, or creep, of the quartz elastic element, since fused, spun silica is an amorphous material. Efforts have been made to obtain ultra-pure quartz in the hope of reducing the drift by reduction of trace amounts of impurities in the quartz, but to no avail. As will be appreciated, improvements in accelerometer design to deal with long term drift are desired.

It is therefore an object of the present invention to provide a novel accelerometer.

### SUMMARY OF THE INVENTION

Accordingly, in one aspect there is provided an accelerometer comprising:

a chamber;

a proof mass supported by an elastic element within said chamber, said elastic element being formed of fused silica;

a sensor sensing displacement of said proof mass; and

means inhibiting interaction of water vapour with said elastic element.

In one embodiment, the means for inhibiting comprises a desiccant provided in the chamber. The desiccant adsorbs water vapour in the chamber. The desiccant comprises a molecular sieve material. The molecular sieve material has pore spaces large enough to adsorb water molecules but small enough to reject molecules of a larger diameter. The chamber is gas filled and the constituents of the gas other than water vapour include only non-polar molecules or polar molecules larger than the diameter of water molecules.

In another embodiment, the inhibiting means comprises a vacuum pump, evacuating the chamber. In yet another embodiment, the inhibiting means comprises a treated surface of the elastic element. The surface is treated by preheating the elastic element to a temperature of about 850° C., treating the elastic element in a stream of dry chlorine gas at a temperature in the range of from about 600 to 1000° C. and then consolidating the elastic element at a temperature of about 1250° C.

The accelerometer may be employed in a gravimeter or seismometer.

According to another aspect there is provided an accelerometer comprising:

a chamber;

a proof mass supported by a fused silica elastic element within said chamber;

a sensor sensing displacement of said proof mass; and

a substantially water vapour free environment surrounding said elastic element.

According to yet another aspect there is provided a method of reducing the drift rate of an accelerometer comprising a chamber housing a fused silica elastic member, said method comprising:

reducing the interaction of the elastic member with water vapour in the chamber.

### BRIEF DESCRIPTION OF THE DRAWINGS

The present invention will be better understood with reference to the accompanying drawing, in which:

FIG. 1 is a side elevation, cross-sectional view of a quartz elastic element gravimeter.

### DETAILED DESCRIPTION OF THE EMBODIMENTS

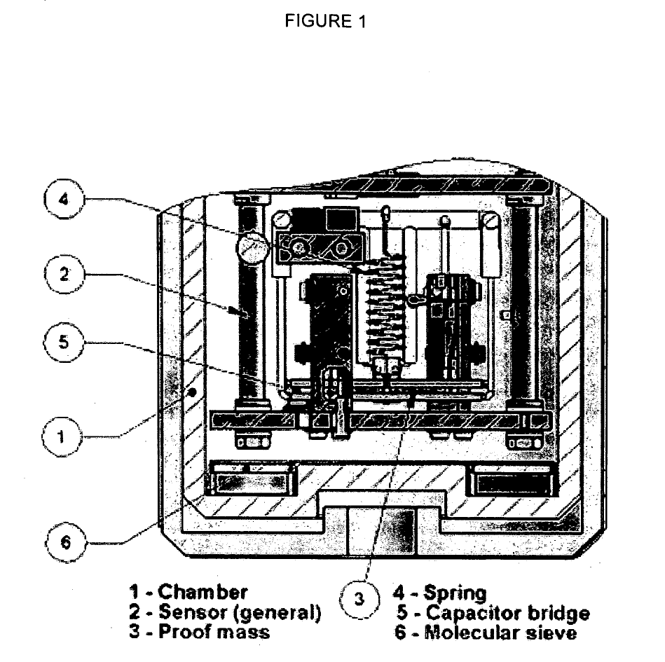

Turning now to FIG. 1, a portion of a quartz elastic element gravimeter is shown. As can be seen, the gravimeter comprises a sealed metal chamber (1) containing an accelerometer (2) which includes a proof mass (3) supported by a flexible quartz elastic element (4). As mentioned above, the quartz elastic element may be for example a spiral spring or torsion hinge formed of fused, spun silica. The pressure of the gas in the chamber (1) is reduced to the lowest level possible consistent with the proper functioning of the accelerometer (2). A capacitive displacement sensor/bridge (5) is disposed beneath the quartz elastic element (4) and senses displacement of the proof mass (3). A container (6) is disposed in the sealed metal chamber (1) beneath the accelerometer (2). The container (6) holds a molecular sieve material selected for its ability to adsorb water.

As is known to those of skill in the art, a change in the force on the proof mass (3) causes a displacement in the position of the proof mass and a change in the length of the supporting quartz elastic element (4). The displacement of the proof mass (3) is sensed by the capacitive displacement sensor/bridge (5) to obtain a measure of the force acting on the proof mass (3). In practice, a restoring force (usually electrostatic) is applied to bring the proof mass (3) back to a standard position, to ensure linearity of measurement.

The molecular sieve material within the container (6) in conjunction with the reduced gas pressure within the chamber (1) ensure that the vapour content in the chamber (1) is maintained at a very low level. Contrary to the prior belief that instrumental drift was the result of an intrinsic vicoplastic creep of the amorphous quartz used to form the quartz elastic element (4), it has been found that the interaction of water vapour with the surface of the quartz accounts for significant instrumental drift. The interaction of the water vapour with the surface of the quartz causes certain changes to the quartz elastic element (4) and also increases the proof mass (3). These changes combine to elongate the quartz elastic element (4), and may simply be regarded as an effective reduction in its elastic coefficient or modulus. When the interaction of the water vapour with the surface of the quartz elastic element (4) continues, it creates a creep or drift.

To confirm that the interaction of water vapour with the quartz elastic element (4) accounts for significant drift in quartz elastic element gravimeters such as that described above, a series of experiments were performed as will now be described.

### Experiment 1

The first experiment performed was to determine the effect of water vapour on a quartz elastic element gravimeter. In this experiment, a quartz elastic element gravimeter such as the CG3 #256 instrument produced by Scintrex Limited of Ontario, Canada was used. The sealed metal chamber of the quartz elastic element gravimeter was firstly evacuated and then backfilled with commercial grade “dry nitrogen” at 150 torr pressure. The residual water vapour content of the “dry nitrogen” is not known, but is believed to be of the order of a few parts per million. The drift rate with that atmosphere, namely about 280 μGals/diem, was regarded as base level for this experiment. The sealed metal chamber was then evacuated to a pressure of less than 10⁻³ torr and exposed to a reservoir of water which was allowed to evaporate into the chamber to saturate its atmosphere. The vapour pressure of water in the chamber at 23° C. would then be 21 torr. The chamber was then backfilled to the original 150 torr pressure, with the same dry nitrogen. The quantity of water vapour was in the order of 14% of the gas in the chamber.

Table 1 below shows the change in the drift rate of the quartz elastic element gravimeter resulting from the addition of a small quantity of water vapour to the gas in the chamber, with the other constituents of the gas and the total vapour remaining unchanged.

TABLE 1
Effect on Drift Rate of the Introduction of Water Vapour

| | Drift Rate |
|---|---|
| Atmosphere | (μGals/diem) |
| 150 torr dry nitrogen, | +280 |
| 150 torr, moist nitrogen | +1250 |

As Table 1 shows, the observed drift rate of the instrument increased from 280 to 1250 μGals/diem when the quartz elastic element was exposed to the water vapour. The interaction of water vapour with the quartz elastic element clearly contributes to the drift rate of the quartz elastic element gravimeter.

Processes involving the interaction of water with the surface of fused silica have been well investigated and are discussed in such references as “The Chemistry of Silica” authored by R. K. Iler, John Wiley and Sons, 1979, and “Adsorption on Solids”, by V. Ponetz et al., London Butterworths, 1974. According to these sources the surface of silica is composed of siloxanes (SiOSi), which, at ordinary temperatures, have an affinity for and interact with the hydroxyl ions in the water vapour to form silanols (SiOH groups). The silicon surface is then said to be hydroxylated. When this process occurs with the quartz elastic element in a gravimeter, atoms are added to the surface of the quartz elastic element and therefore, its mass increases. This process is not limited to the apparent surface of the quartz elastic element. Hydroxl ions also penetrate below the surface of the quartz elastic element (i.e. are adsorbed), at a slower rate, into micropores or micro-capillaries in the body of the quartz elastic element. In addition to the increase in mass, the absorption process induces physical changes and possibly decreases the surface tension of the quartz elastic element. Both effects of the interaction of water vapour with the surface of the quartz elastic element result in an extension of the quartz elastic element i.e. an increase of apparent gravity. While the water vapour/quartz reaction continues, at a rate determined by the concentration of water vapour in the chamber and the availability of un-hydroxylated siloxanes, the effect is to create a long term positive drift in the gravity measurement.

### Experiment 2

The second experiment was to determine the effect reducing the gas pressure has on the drift rate of a quartz elastic element gravimeter. In this experiment, a CG3 #161 quartz elastic element gravimeter produced by Scintrex Limited used.

In this experiment, the drift rate of the quartz elastic element gravimeter was measured when the chamber of the quartz elastic element gravimeter was filled with commercial grade “dry nitrogen” at a pressure of 150 torr. A vacuum pump was then used to evacuate the chamber until the pressure in the chamber reached 1 torr. The drift rate of the quartz elastic element gravimeter was again measured.

Table 2 below shows the change in the drift rate of the quartz elastic element gravimeter resulting from the reduction in pressure of the gas in the chamber, the composition of the gas remaining the same.

TABLE 2
Effect on Drift Rate of Reducing the Gas Pressure

| | Drift Rate |
|---|---|
| Atmosphere | (μGals/diem) |
| 150 torr dry nitrogen | +610 |
| 1 torr dry nitrogen | −20 |

As can be seen in Table 2, by decreasing the pressure in the chamber of the quartz elastic element gravimeter, drift is effectively eliminated. This clearly demonstrates that the drift depends on the continued availability of water vapour. The very small negative drift that remains is attributed to the removal of loosely bonded surface water being released under the low pressure. Tables 1 and 2 above confirm that, contrary to commonly accepted belief, the long term drift rate of quartz elastic element accelerometers, such as gravimeters, is not an intrinsic property of the quartz elastic element, but is predominantly determined by the presence and concentration of water vapour in the gaseous environment surrounding the quartz elastic element.

As Table 2 shows, one means of reducing the water vapour concentration in the chamber housing the quartz elastic element is to exhaust the gas in the chamber. Alternatively, a gas which is totally devoid of water vapour can be used. As will be appreciated, gas of this purity is difficult to obtain. Even if zero water vapour concentration can be established in the chamber at one particular time, steps must be taken to prevent small amounts of water vapor from entering the chamber after sealing. This requires very positive sealing, using metal-metal seals rather than permeable seals such as Viton. Even so, there may be outgassing from components of the gravimeter and, with time, water vapour may be introduced into the chamber resulting in instrumental drift.

Given these practical limitations to the long term reduction of the water vapour content of the gas in the chamber, one way of achieving effective and long term water vapour content reduction is to provide means to continuously remove water vapour from the chamber. Whereas this could be accomplished through the continuous use of a vacuum pump, this is a ponderous and inconvenient approach. Using a desiccant to remove water vapour is a much more practical approach. As is known, several basic types of desiccants exist, including silica gell, clay, carbon and molecular sieves. The latter offer the best advantage. Molecular sieves can selectively remove water vapour, even at very low levels, from a mixture of gases. Molecular sieves are crystalline metal aluminosilicates (or zeolites) having a three-dimensional interconnecting network of silica and alumina tetrahedra. Natural water of hydration is removed from this network by heating, to produce extremely uniform cavities which selectively adsorb molecules, up to a specific size, which are polar, and which are less efficient for any non-polar molecules or molecules of larger size.

Water is a polar molecule because of the way that the atoms bind in the molecule such that there is an excess of positive charges on the hydrogen side of the molecule and an excess of electrons on the oxygen side. Non-polar molecules have their electrons distributed more symmetrically about the molecule, so that there is no excess of charge at the opposite sides. Non-polar gases include nitrogen, oxygen and carbon dioxide, as well as all the noble gases such as helium, neon, krypton and xenon. Thus, a molecular sieve can selectively extract water vapour, even at very low concentrations, from an atmosphere with much higher concentrations of non-polar gases (e.g. nitrogen). Thus, providing that other constituents of the gas in contact with the quartz elastic element are non-polar (or, if polar, are of molecular sizes much larger than that of water), then an appropriate molecular sieve will be a highly selective and effective means for removing water vapour in the chamber.

Changing the ratio of Si/Al can affect the size of molecules that can be adsorbed, typically over the range from 3 to 30 Angstroms (0.3 to 3 nm). Water molecules have a diameter of 3.2 Angstroms, which determines the selection of a molecular sieve that is best suited to adsorb water vapour. For example, a commercially available molecular sieve such as Type 4A, produced by Sigma-Aldrich of Missouri, U.S.A. may be used. Molecular sieves have several other characteristics which are advantageous. For instance, they have a much higher equilibrium capacity for water vapour under very low humidity conditions, and are very effective in reducing the water vapour content of gases well below the part-per-million level. In addition, they can continue to adsorb water vapour at temperatures in excess of 150° C., although with diminished adsorption capacity above 40° C.

### Experiment 3

The third experiment was to determine the effect a molecular sieve desiccant placed in the chamber of a quartz elastic element gravimeter has on its drift rate. In this experiment, a CG3 #256 quartz elastic element gravimeter produced by Scintrex Limited was used.

In this experiment, the drift rate of the quartz elastic element gravimeter was measured when the chamber of the quartz elastic element gravimeter was filled with moist nitrogen at a pressure of 150 torr with a molecular sieve present in the chamber. An ADCOA Type 4-4 molecular sieve produced by Signman-Aldrich of Missouri, U.S.A. was used.

Initially, the chamber was firstly evacuated for five minutes. The molecular sieve, which was present in the chamber, was regenerated by this process. Then, as for Experiment 1, the chamber was exposed to a reservoir of water which was allowed to evaporate into the chamber, to saturate its atmosphere. The vapour pressure of water in the chamber (at 23° C.) would then be 21 torr. The chamber was then backfilled, to the original 150 torr pressure, with the same dry nitrogen.

Table 3 below shows the drift rate of the quartz elastic element gravimeter with the molecular sieve in the chamber compared to the quartz elastic element gravimeter of Experiment 1 when the chamber was filled with moist nitrogen at a pressure of 150 torr.

TABLE 3
Effect on Drift Rate of the use of a Molecular Sieve

| | Drift Rate, |
|---|---|
| Conditions | μGals/diem |
| 150 torr moist nitrogen, molecular sieve present | +0 |
| 150 torr moist nitrogen, molecular sieve removed | +1250 |

As can be seem from Table 3, the observed drift rate of the quartz elastic element gravimeter with the molecular sieve was zero. As will be appreciated with reference to Table 1, with the same quartz elastic element gravimeter, when the chamber was filled with moist nitrogen at a pressure of 150 torr and no molecular sieve was present, the drift rate was found to be 1250 μGals/diem.

Since nitrogen is a non-polar gas, and since the effect of the particular molecular sieve is for the selective removal of water vapour, two conclusions from the experiments reported in Table 3 can be drawn. Firstly, the results strongly reinforce the conclusion that the drift rate of quartz elastic element accelerometers is due to the presence of water vapour in contact with the quartz elastic element, and, secondly, that a properly selected desiccant, such as a molecular sieve, is highly effective in reducing the drift rate.

In the above experiments, reducing drift in quartz elastic elements gravimeters by reducing the water vapour content in the chamber housing the quartz elastic elements is achieved by using a desiccant or by evacuating the chamber. Those of skill in the art will however appreciate that other techniques to reduce the interaction of water vapour with the surface of the quartz elastic element can be used such as for example the technique disclosed in U.S. Pat. No. 3,459,522 to Thomas H. Elmer and Martin E. Nordberg. In this patent, a procedure for producing a substantially water-free silica surface is suggested by the sequential steps of preheating the silicon surface to a temperature of about 850° C., treating the silicon surface in a stream of dry chlorine gas at a temperature in the range of from about 600 to 1000° C., and then consolidating the silicon surface at a temperature of about 1250° C. Applying this procedure to the quartz elastic element will also reduce the rate of reaction of the quartz surface with water vapour in the chamber and thus, will reduce instrument drift rate.

The discovery that the drift of quartz elastic element accelerometers is not an intrinsic property of quartz elastic elements, but is due to the interaction of water vapour with the elastic element surface, provides the basis for devising an effective means of reducing instrumental drift. As discussed above, reducing water vapour pressure in the chamber, using a desiccant or treating the quartz elastic element surface can reduce instrumental drift. If desired, the above techniques can be used in combination to achieve the desired reduction in water vapour interaction with the quartz elastic element. Of course, other water vapour interaction reduction techniques may be used.

Although embodiments have been described above with reference to FIG. 1, those of skill in the art will appreciate that variations and modifications may be made without departing from the spirit and scope thereof as defined by the appended claims.

What is claimed is:

1. An accelerometer comprising:
a chamber;
a proof mass supported by an elastic element within said chamber, said elastic element being formed of fused silica;
a sensor sensing displacement of said proof mass; and
means inhibiting interaction of water vapour with said elastic element.

2. An accelerometer according to claim 1 wherein said elastic element is formed of fused silica.

3. An accelerometer according to claim 2, wherein said inhibiting means comprises a desiccant in said chamber, said desiccant adsorbing water vapour in the chamber.

4. An accelerometer according to claim 3, wherein said desiccant comprises a molecular sieve material.

5. An accelerometer according to claim 4, wherein said molecular sieve material has pore spaces large enough to adsorb water molecules but small enough to reject molecules of a larger diameter.

6. An accelerometer according to claim 5 wherein said chamber is gas filled and wherein the constituents of said gas other than water vapour include only non-polar molecules, or polar molecules larger than the diameter of water molecules.

7. An accelerometer according to claim 2, wherein said inhibiting means comprises a vacuum pump evacuating said chamber.

8. An accelerometer according to claim 2, wherein said inhibiting means comprises a treated surface of said elastic element.

9. An accelerometer according to claim 8 wherein said surface is treated by preheating the elastic element to a temperature of about 850° C., treating the elastic element in a stream of dry chlorine gas at a temperature in the range of from about 600 to 1000° C., and then consolidating the elastic element at a temperature of about 1250° C.

10. An accelerometer according to claim 1 employed in a gravimeter.

11. An accelerometer according to claim 1 employed in a seismometer.

12. An accelerometer comprising:
a chamber;
a proof mass supported by a fused silica elastic element within said chamber;
a sensor sensing displacement of said proof mass; and
a substantially water vapour free environment surrounding said elastic element.

13. An accelerometer according to claim 12, further comprising a desiccant in said chamber, said desiccant adsorbing water vapour in the chamber.

14. An accelerometer according to-claim 13, wherein said desiccant comprises a molecular sieve material.

15. An accelerometer according to claim 14, wherein said molecular sieve material has pore spaces large enough to adsorb water molecules but small enough to reject molecules of a larger diameter.

16. An accelerometer according to claim 12, further comprising a vacuum pump evacuating said chamber thereby to create said water vapour free environment.

17. An accelerometer according to claim 13, further comprising a vacuum pump evacuating said chamber thereby to create said water vapour free environment.

18. An accelerometer according to claim 12 employed in a gravimeter.

19. An accelerometer according to claim 12 employed in a seismometer.

20. A method of reducing the drift rate of an accelerometer comprising a chamber housing a fused silica elastic member, said method comprising:
reducing the interaction of the elastic member with water vapour in the chamber.

21. The method of claim 20, wherein said reducing comprises evacuating gas in the chamber.

22. The method of claim 20, wherein said reducing comprises placing a desiccant, with selective affinity for water vapour, in the chamber.

23. The method of claim 22, wherein said desiccant is a molecular sieve.

24. The method of claim 20, wherein said reducing comprises treating the surface of the elastic member to prevent its interaction with water vapour.

25. The method of claim 24, wherein said treating comprises:
preheating the elastic member to a temperature of about 850° C.;
treating the elastic member in a stream of dry chlorine gas at a temperature in the range of from about 600 to 1000° C.; and
consolidating the elastic member at a temperature of about 1250° C.

26. The method of claim 21, wherein said reducing further comprises placing a desiccant, with selective affinity for water vapour, in the chamber.

27. The method of claim 21 wherein said reducing further comprises treating the surface of the elastic member to prevent its interaction with water vapour.

28. The method of claim 27, wherein said treating comprises:
preheating the elastic member to a temperature of about 850° C.;
treating the elastic member in a stream of dry chlorine gas at a temperature in the range of from about 600 to 1000° C.; and
consolidating the elastic member at a temperature of about 1250° C.

29. The method of claim 22, wherein said reducing further comprises treating the surface of the elastic member to prevent its interaction with water vapour.

30. The method of claim 29, wherein said treating comprises:
preheating the elastic member to a temperature of about 850° C.;
treating the elastic member in a stream of dry chlorine gas at a temperature in the range of from about 600 to 1000° C.; and
consolidating the elastic member at a temperature of about 1250° C.

31. The method of claim 29, wherein said reducing further comprises evacuating gas in the chamber.
